(19) United States
(12) Patent Application Publication
(10) Pub. No.: US 2006/0284598 A1
(43) Pub. Date: Dec. 21, 2006

(54) Method and device in a multi-celled battery pack for disabling charging

(76) Inventor: Seng P. Xiong, Dacula, GA (US)

Correspondence Address: MOTOROLA, INC.;LAW DEPARTMENT, 600 NORTH U.S. HIGHWAY 45, AS437, LIBERTYVILLE, IL, 60048, US

(21) Appl. No.: 11/157,000

(22) Filed: Jun. 20, 2005

(51) Int. Cl. H02J 7/00

(52) U.S. Cl. 320/128

(57) ABSTRACT

Disclosed are a method, processor and device for charging of multi-celled battery pack (101) is disclosed to determine if one or more cells (A, B, C and D) is malfunctioning. The battery pack has a voltage (114) and includes a discharge FET (104) which when open prevents discharge of the battery pack and which when closed allows discharge. The method includes establishing a predetermined rapid charge error threshold, applying a rapid charge current the battery pack (304), determining whether the discharge FET is open (308), determining whether the voltage of the battery pack exceeds the rapid charge error threshold (306) and disabling charging when the voltage exceeds the rapid charge error threshold and the discharge FET is open (310).

### FIELD OF THE INVENTION

This invention relates to rechargeable multi-celled battery packs and in particular to a method, processor and device for determining if one or more cells are malfunctioning.

### BACKGROUND

Power supply voltages for electronic devices vary greatly from as little as 2.5V to as many as 48 volts or more. Traditionally plug-in devices are becoming available as portable devices. To avoid waste and the cost of battery replacement, rechargeable batteries are oftentimes employed as energy sources for portable devices. Higher voltage batteries are required by some portable electronic devices. Higher voltage rechargeable batteries include battery packs having a plurality of smaller cells in series as opposed to having a single larger cell.

While rechargeable cells avoid the problems of waste and the cost of battery replacement, individual battery cells can deteriorate with usage and age. Also, cells upon manufacture may be defective. Because the rate of deterioration will vary from cell to cell, it is possible to have a battery pack with both good cells and also bad cells that are no longer usable. Once a battery pack has one or more damaged cells, it should no longer be charged or discharged.

Since overcharging and overdischarging cells in a battery pack can degrade the battery pack performance and may lead to a hazardous situation, safety circuitry has been installed in battery packs. Safety circuitry is provided to prevent simple overcharging and overdischarging. Battery packs typically employ safety circuitry that does not allow current to pass under certain conditions, thus overcharging or overdischarging may be avoided. The safety circuitry includes its surrounding auxiliary components such as charge and discharge FETs (Field Effect Transistors) and its own protection IC (Integrated Circuit). Generally, safety circuitry is controlled by its stand alone protection IC. A separate microprocessor may further process the output of the safety circuitry to determine the state of the charging battery pack. The microprocessor may work in tandem with the “safety circuitry” to further enhance cell performance.

For example, battery packs typically employ circuit devices, such as a charge FET and a discharge FET that are controlled by a protection IC as a part of its safety circuitry. The protection IC monitors the voltages of the individual cells. Therefore, in the event the pack includes a bad cell with a low cell voltage, the safety circuit can detect an over-discharged cell. However, the safety circuitry will not necessarily open the charge FET which would disable charging of the defective cell. The logic of the protection IC allows the charge FET to remain closed in an “attempted charging,” since if the cell is not defective, it may recover if it were allowed to continue to charge. Attempted charging can continue until one or more of the other cells reaches an overcharge voltage state (standard termination may be 4.1 volts per cell, while overcharge may be 4.3 or so). Overcharging a cell may cause a hazardous condition. The microprocessor, on the other hand, monitors the voltage of the battery pack as a whole (called the stack voltage) to determine when charge termination occurs, which is indicated when the battery pack reaches the charge termination voltage.

In an overdischarge situation, the battery pack may irreversibly lose its ability to hold a charge. To avoid such a situation, when a cell in the battery pack is determined to be overdischarged, the protection IC will open the discharge FET to prevent the battery pack from further discharging until that cell voltage climbs back above a certain voltage threshold. In order for the battery pack to recover from overdischarge, the protection IC allows the battery pack to be charged by having the charge FET remain closed, so current can be applied to the overdischarged cell.

On the other hand, when the battery pack is determined to be overcharged, the protection IC may open the charge FET. However, there may be a charging situation (for example, with a damaged cell) where a cell continues to draw charging current but does not reach its charge termination voltage. In such a case the undercharging cell is probably damaged. Even though the protection IC of the safety circuitry monitors the individual cell voltages, in attempted charging as discussed above, the protection IC may not distinguish between an overdischarged cell and a damaged cell. Accordingly, the safety circuitry may not open the charge FET because the safety circuitry may attempt cell recovery by continuing to apply charge current. If a cell cannot reach its charge termination voltage, the other cells in the pack may become overcharged as a result of the protection IC continuing to charge (attempting to recover the undercharged cell). Overcharging can damage the cells. It would be beneficial during charging to detect the situation where one or more cells are damaged.

Increasing logic functions of the protection IC so that it may distinguish between an overdischarged cell and a damaged cell to determine which particular ones of the cells are damaged or faulty would be expensive given price constraints of the market. In the case that a microprocessor is embedded in the battery pack, adding additional I/Os to monitor the individual cell voltages for each cell is not practical since the microprocessors used in these applications are relatively small and therefore have a limited space for additional I/Os. In a microprocessor external to the battery pack, for similar and other reasons adding I/Os may not be possible. None of these options is cost effective.

There is thus a need for an improved circuit and method for determining whether a cell within the battery pack is damaged.

### BRIEF DESCRIPTION OF THE DRAWINGS

FIG. 1 is a circuit diagram of an embodiment of a battery pack with an embedded microprocessor;

FIG. 2 is a circuit diagram of an embodiment of a battery pack with an external microprocessor; and

FIG. 3 is a flowchart of an exemplary charging process.

### DETAILED DESCRIPTION OF THE INVENTION

A method, processor and device are disclosed for charging a multi-celled battery pack and determining if one or more cells are malfunctioning. Since a damaged or malfunctioning cell may be a safety concern, when that condition is detected in accordance with the disclosed method, processor and device, the microprocessor will disengage the charging of the battery pack.

Herein described is a combination of two conditions that the microprocessor can detect that will determine if one or more cells is malfunctioning so that the microprocessor will disable all charging and indicate a rapid charge error. The battery pack, which has a voltage, includes a discharge field effect transistor (FET) which when open prevents discharge of the battery pack and which when closed allows discharge. As one condition, in applying a rapid charge current to the battery pack, the microprocessor determines if the discharge FET is open. As another condition, the microprocessor further determines whether the voltage of the battery pack exceeds a predetermined rapid charge error threshold. If both these conditions are detected, the microprocessor determines that one or more cells is malfunctioning, and disables all charging of the battery pack.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

A microprocessor can be embedded into the battery pack or be external to the battery pack. The microprocessor monitors the charge FET and discharge FET control lines from the safety circuit and the stack voltage to identify one or more damaged cells in a battery pack. In the case of a battery pack with an integrated microprocessor, the voltage and control lines are monitored directly. In the case of a battery pack without an integrated microprocessor, the battery charge/discharge current and cell stack voltage are monitored. The microprocessor with appropriate software or hardwired configuration can disengage the charging of a battery pack when the two conditions, described above, are met. The microprocessor can further monitor the stack voltage, current, time duration of charging and temperature of the battery pack to help ensure safety.

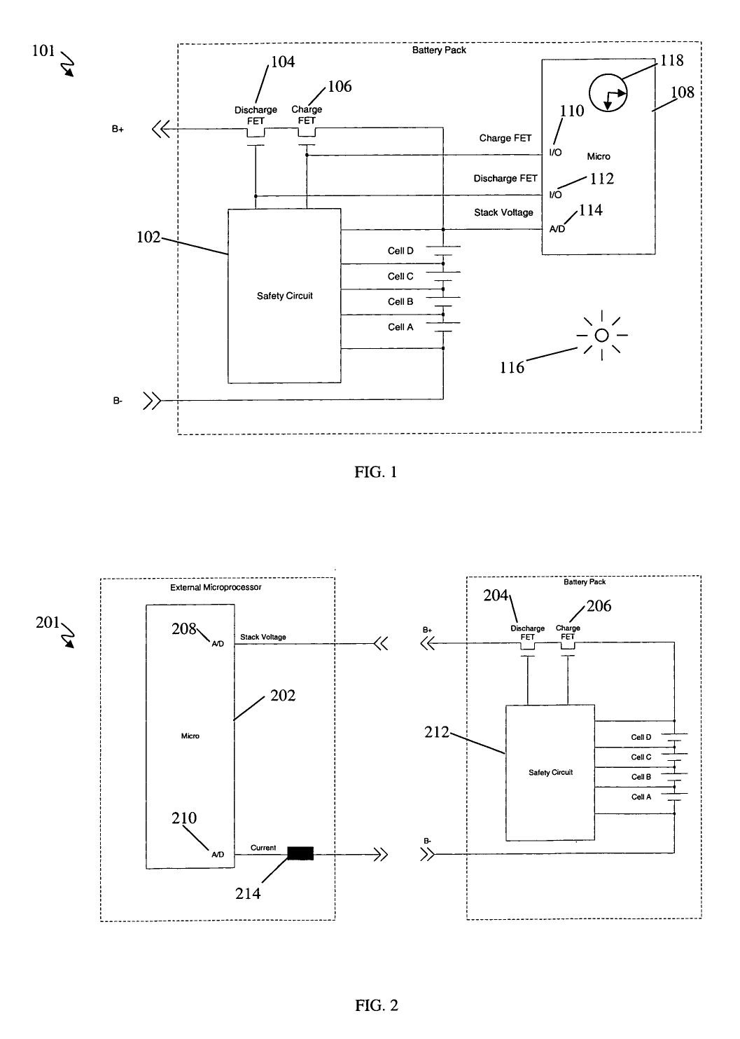

FIG. 1 is a circuit diagram of an embodiment of a battery pack 101 with an embedded microprocessor. By contrast, FIG. 2 is a circuit diagram of an embodiment of a battery pack 201 with an external microprocessor. First turning to FIG. 1, a battery pack 101 that uses for example four lithium cells in series A, B, C and D, and protection IC or safety circuit 102 is shown. The safety circuit 102 is in communication with the discharge FET 104 and the charge FET 106. The safety circuit 102 applies a voltage to the discharge FET to keep the discharge FET closed, and applies a voltage to the charge FET to keep the charge FET closed. In this way, current may pass therethrough. Accordingly, the safety circuit may control the state of either or both of the discharge FET 104 and charge FET 106. Signals carrying discharge and charge FET state information are received by the embedded microprocessor 108 at I/O ports. That is, the microprocessor 108 detects the charge and the discharge FET control lines to determine whether they are high or they are low 110 and 112, respectively. In addition stack voltage is applied to I/O port 114.

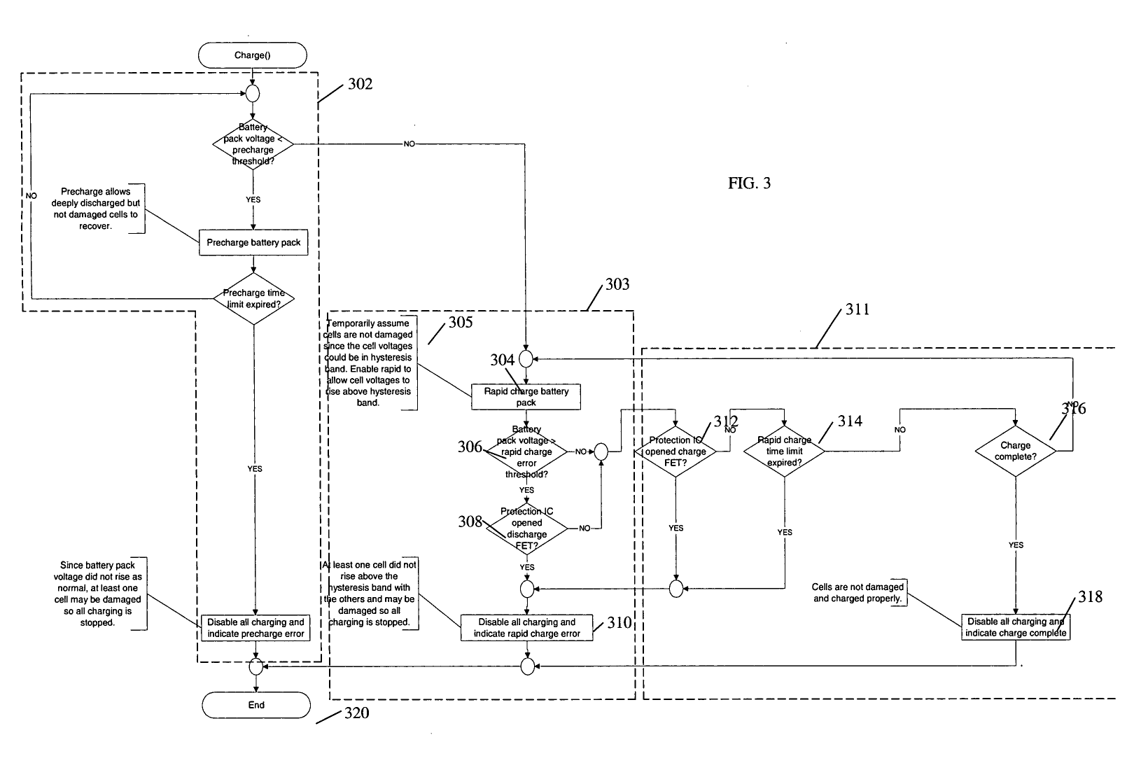

When particular signals are received from the safety circuit at I/O ports 112 and 114 of the embedded microprocessor 108, there may be a safety condition. From the state information of both the discharge FET (open) and the stack voltage (exceeding the rapid charge error threshold), the embedded microprocessor 108 can detect the two conditions that indicate that at least one cell may be defective. A rapid charge error threshold is a numerical value associated with the battery pack parameters. In particular, when the cells reach their discharge threshold, the protection IC opens the discharge FET. Due to hysteresis, the discharge FET will not close until the cells rise above their discharge threshold plus a delta. The error threshold is the number of cells multiplied by the discharge voltage plus the delta plus some optional allowance. For example, when the discharge threshold voltage is 2.5 V, the discharge plus delta (to close the discharge FET) may be 2.7 V. In this example, the error threshold for a four cell pack is 2.7 V*4 plus an allowance (if used). Accordingly, the extended rapid charging of a damaged cell pack can be prevented by application of the algorithm shown in FIG. 3 and discussed in detail below. Therefore, in an embodiment where the microprocessor 108 is embedded inside the battery pack, the protection IC outputs that control the charge and discharge FETs can be monitored directly by the microprocessor.

Indicator light 116 may indicate to a user that there is a safety condition. A timer or timing circuit 118 may be incorporated in the microprocessor to monitor the time duration of the rapid charging process. If too much time passes while the battery pack is engaging in a charging routine, then the microprocessor may shut down the charging process and the indicator light 116 will indicate a safety condition. That is, if the battery pack voltage stays below its charge termination voltage beyond the given time limit, at least one cell is presumed damaged and all charging is stopped.

Now turning to FIG. 2, a battery pack circuit 201 is shown that includes an external microprocessor 202 that is external to the battery pack. The external microprocessor may be part of a charger, for example. In that case, the protection IC outputs that control the discharge FET 204 and charge FET 206 can be indirectly monitored through the microprocessor's measurements of the stack voltage and current through the battery pack, through analog-to-digital (A/D) converter inputs 208 and 210, respectively. The stack voltage can be monitored at 208. The microprocessor can determine the magnitude and direction of current flow through the battery pack at 210. The external microprocessor can detect that the charge FET is open if the current is zero, when the external charger is trying to apply a non-zero charge current. The microprocessor therefore infers that the charge FET is open. The external microprocessor can detect that the discharge FET is open if the current is zero, when the external charger is trying to apply a non-zero discharge current. The microprocessor therefore infers that the discharge FET is open.

When the microprocessor detects through inputs 208 and 210 that discharge FET 204 is open or charge FET 206 is open, via the safety circuit 212, the microprocessor 202 will determine that the safety circuit 212 detected a overdischarge or overcharge condition. The black box 214 is a current sense and can be, for example, a resistor, a transformer, or a hall effect current detector. In one embodiment, the microprocessor 208 opens the charge FET when the two conditions are detected (i.e. open discharge FET and exceeding rapid error threshold). The microprocessor can process the state information and excess stack voltage information to determine that at least one cell, of A, B, C or D, has a problem.

An algorithm of the described method, processor and device provides for the embedded microprocessor 108 in the embodiment of FIG. 1 or the external microprocessor 202 in the embodiment of FIG. 2 to disconnect the charge path to the cells when a presumed damaged cell is detected. The discussion of the algorithm of FIG. 3 is made with respect to the embedded battery pack embodiment of FIG. 1.

Prior to the rapid charge, it is customary for a slower precharge 302 to be applied to the battery pack for certain voltages. In other situations, the rapid charge is applied directly. Precharge is applied when the battery pack is below the precharge threshold. The precharge 302 is indicated by dashed lines around several boxes in the flow chart. The slower precharge 302 takes place to prepare the battery pack for the rapid charge 303. For the rapid charge 303, indicated by dashed lines around rapid charge boxes in the flow chart, a rapid charge error threshold is established according to the specifications of the circuit and hard-wired or programmed into the microprocessor 108. As previously discussed, the rapid charge error threshold value defines one of the above-mentioned two conditions in the algorithm.

The rapid charging of the battery pack is initiated 304, based on an assumption that cells are not damaged. A rapid charge current is applied to the battery pack 304. It is during the rapid charging process that there is a determination by the microprocessor whether the voltage of the battery pack exceeds the rapid charge error threshold 306. Additionally, the microprocessor determines whether the discharge FET is open 308. If both conditions, that the rapid charge error threshold is exceeded and the discharge FET is open, are detected then charging is disabled and there is an indication that there is a rapid charge error 310.

If it is determined that neither condition 306 or 308 is met, then the safety circuit can still disable charging according to boxes of the algorithm enclosed in dashed line 311. The safety circuit 102 may open the charge FET 312 and charging ends. Otherwise, there is a query as to whether the rapid charge time limit has expired 314, and if so, charging ends. If the charge is complete 316, then all charging is disabled and the process ends 320.

For illustration purposes, a list of possible scenarios is below described. A battery pack like that shown in FIGS. 1 and 2 that uses 4 lithium cells in series, A, B, C and D, with the protection IC 102 (or 212) detecting overdischarge at 2.000V±0.080V and no longer detecting overdischarge at 2.700V±0.100V and overcharge at 4.250V±0.025V is assumed. The precharge threshold is set to 10.00V and the rapid charge error threshold is set at 12.00V.

For all scenarios, the charge algorithm as illustrated in FIG. 3 will detect damaged cells. For example:
1. Cell A was previously detected as overdischarged but is still less than 2.7V while B, C, and D are greater than 2.7V. In this circumstance, the discharge FET remains open.
   a. If 8.1V<A+B+C+D<10.0V, pre-charge until pre-charge timeout or charge FET opens.
   b. If 10.0V<A+B+C+D<12.0V, rapid charge until rapid charge timeout or charge FET opens.
   c. If A+B+C+D>12.0V, stop charge since discharge FET is open.
2. Cells A and B were previously detected as overdischarged and are still less than 2.7V while C and D are greater than 2.7V.
   a. If 5.4V<A+B+C+D<10.0V, pre-charge until pre-charge timeout or charge FET opens.
   b. If 10.0V<A+B+C+D<12.0V, rapid charge until rapid charge timeout or charge FET opens.
   c. If A+B+C+D>12.0V, stop charge since discharge FET is open.
3. Cells A, B, and C were previously detected as overdischarged and are still less than 2.7V while D is greater than 2.7V.
   a. If 2.7V<A+B+C+D<10.0V, pre-charge until pre-charge timeout or charge FET opens.
   b. If 10.0V<A+B+C+D<12.0V, rapid charge until rapid charge timeout or charge FET opens.
   c. If A+B+C+D>12.0V, stop charge since discharge FET is open.
4. Cells A, B, C, and D were previously detected as overdischarged and are still less than 2.7V.
   a. If 0.0V<A+B+C+D<0.0V, pre-charge until pre-charge timeout.
   b. If 10.0V<A+B+C+D<10.8V, rapid charge until rapid charge timeout.

Accordingly, when the microprocessor is embedded inside the battery pack, the protection IC outputs that control the charge and discharge FETs can be directly monitored by the microprocessor. From the state of the charge and discharge FETs and the stack voltage, the embedded microprocessor 108 can detect the conditions that indicate that at least one cell may be defective. If the microprocessor is external from the battery pack, the protection IC outputs that control the charge and discharge FETs can be indirectly monitored through the microprocessor's measurement of voltage and current. In either case, when these outputs are monitored, the microprocessor can determine if the two above-described conditions are met and determine whether the protection IC detected a safety condition. Accordingly it can be inferred whether at least one cell has a problem and charging may be disabled and an error indication can be provided.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method for charging of a battery pack having a voltage, the battery pack comprising a discharge FET which when open prevents discharge of the battery pack and which when closed allows discharge, the method comprising:
establishing a predetermined rapid charge error threshold;
applying a rapid charge current the battery pack;
determining whether the discharge FET is open;
determining whether the voltage of the battery pack exceeds the rapid charge error threshold; and
disabling charging when the voltage exceeds the rapid charge error threshold and the discharge FET is open.

2. The method of claim 1, wherein the battery pack further comprises a protection IC and the protection IC has an output that controls the discharge FET, and wherein determining whether the discharge FET is open comprises:
monitoring the output of the protection IC.

3. The method of claim 1, wherein the battery pack further comprises a protection IC and the protection IC has an output that controls the discharge FET, and wherein determining whether the discharge FET is open comprises:
indirectly monitoring the output of the protection IC.

4. The method of claim 1, wherein the battery pack further comprises a charge FET which when open prevents charging and which when closed allows charging, the method further comprising:
determining whether the charge FET is open; and
disabling charging when the voltage exceeds the rapid charge error threshold, the discharge FET is closed, and the charge FET is open.

5. The method of claim 4, wherein the battery pack further comprises a protection IC, the protection IC has an output that controls the charge FET, and wherein determining whether the charge FET is open comprises:
monitoring the output of the protection IC.

6. The method of claim 4, wherein the battery pack further comprises a protection IC, the protection IC has an output that controls the charge FET, and wherein determining whether the charge FET is open comprises:
indirectly monitoring the output of the protection IC.

7. The method of claim 1, wherein the battery pack further comprises a charge FET which when open prevents charging of the battery pack and which when closed allows charging, the method further comprising:
determining whether the charge FET is open; and
disabling charging when the voltage is below the rapid charge error threshold and the charge FET is open.

8. The method of claim 7, wherein the battery pack further comprises a protection IC, the protection IC has an output that controls the charge FET, and wherein determining whether the charge FET is open comprises:
directly monitoring the output of the protection IC.

9. The method of claim 7, wherein the battery pack further comprises a protection IC, the protection IC has an output that controls the charge FET, and wherein determining whether the charge FET is open comprises:
indirectly monitoring the output of the protection IC.

10. The method of claim 1, adapted to applying a rapid charge time limit, the method further comprising:
disabling charging when the rapid charge time limit has expired.

11. The method of claim 1, further comprising:
indicating a rapid charge error upon disabling charging.

12. A processor adapted to execute instructions for regulating charging of a battery pack having a voltage, the battery pack comprising a discharge FET which when open prevents discharge of the battery pack and when closed allows discharge, the method adapted to applying a rapid charge error threshold, the instructions comprising:
an initiation module for initiating applying a rapid charge current to the battery pack;
a discharge FET module for determining whether the discharge FET is open;
an error threshold module for determining whether the voltage of the battery pack exceeds the rapid charge error threshold; and
a charge disabling module for disabling charging when the voltage exceeds the rapid charge error threshold and the discharge FET is open.

13. The processor of claim 12, wherein the battery pack further comprises a charge FET which when open prevents charging of the battery pack and which when closed allows charging, the instructions further comprising:
a charge FET module for determining whether the charge FET is open;
wherein the charge disabling module is for disabling charging when the voltage exceeds the rapid charge error threshold, the discharge FET is closed, and the charge FET is open.

14. The processor of claim 12, wherein the battery pack further comprises a charge FET which when open prevents charging of the battery pack and which when closed allows charging, the instructions further comprising:
a charge FET module for determining whether the charge FET is open;
wherein the charge disabling module is for disabling charging when the voltage is below the rapid charge error threshold and the charge FET is open.

15. The processor of claim 12, further adapted to applying a rapid charge time limit, the instructions further comprising:
a timing module for determining whether the rapid charge time limit has expired;
wherein the charge disabling module is for disabling charging when the rapid charge time limit has expired.

16. A device for charging of a battery pack, the battery pack having a voltage, the device comprising:
a charger adapted for applying a rapid charge current to the battery pack;
a voltage sensor adapted to determine the voltage of the battery pack;
a discharge FET which when open prevents discharge of the battery pack and which when closed allows discharge; and
a regulator configured with a rapid charge error threshold and operatively connected to the charger, the voltage sensor and the discharge FET, the regulator for determining whether the discharge FET is open and whether the voltage exceeds the rapid charge error threshold according to the voltage sensor, and for disabling charging when the voltage exceeds the rapid charge error threshold and the discharge FET is open.

17. The device of claim 16, further comprising:
a charge FET, which when open prevents charging of the battery pack and which when closed allows charging, in operative connection with the regulator;
wherein the regulator is for determining whether the charge FET is open, and for disabling charging when the voltage exceeds the rapid charge error threshold according to the voltage sensor, the discharge FET is closed, and the charge FET is open.

18. The device of claim 16, further comprising:
a charge FET, which when open prevents charging of the battery pack and which when closed allows charging, in operative connection with the regulator;
wherein the regulator is for determining whether the charge FET is open, and for disabling charging when the voltage is below the rapid charge error threshold according to the voltage sensor and the charge FET is open.

19. The device of claim 16, wherein the regulator is further configured with a rapid charge time limit, and is for disabling charging when the rapid charge time limit has expired.

20. The device of claim 16, wherein the regulator is for indicating a rapid charge error when the voltage exceeds the rapid charge error threshold according to the voltage sensor, and the discharge FET is open.
